(19) United States
(12) Patent Application Publication
(10) Pub. No.: US 2023/0168343 A1
(43) Pub. Date: Jun. 1, 2023

(54) Object and Environment Dimensioning Based on UWB Radios

(71) Applicant: Motorola Mobility LLC, Chicago, IL (US)

(72) Inventors: Michael E. Russell, Lake Zurich, IL (US); Jarrett K. Simerson, Northbrook, IL (US); Thomas Yates Merrell, St Charles, IL (US)

(73) Assignee: Motorola Mobility LLC, Chicago, IL (US)

(21) Appl. No.: 17/536,499

(22) Filed: Nov. 29, 2021

(51) Int. Cl. G01S 7/41; G01S 13/42; G01S 13/86

(52) U.S. Cl. CPC G01S 7/41; G01S 13/42; G01S 13/867

(57) ABSTRACT

In aspects of object and environment dimensioning based on UWB radios, a system includes objects in an environment that are tagged objects and non-tagged objects. The system includes ultra-wideband (UWB) radios associated with respective tagged objects in the environment. A mapping module is implemented to determine a location of each of the tagged objects in the environment based on a position of the UWB radio associated with a tagged object, and determine a location of each of the non-tagged objects in the environment based on the positions of the UWB radios. The mapping module can also determine dimensions of the environment and the objects based on the location and a relative position of each tagged object and non-tagged object in the environment. In implementations, one or more of the UWB radios are UWB tags located for association with the respective tagged objects.

### BACKGROUND

Ultra-wideband (UWB) is a radio technology that can be utilized for secure, spatial location applications using very low energy for short-range, high-bandwidth communications. The technology is detailed by the IEEE 802.15.4z standard for Enhanced Ultra-Wideband (UWB) Physical Layers (PHYs) and Associated Ranging Techniques for accurate relative position tracking, which provides for applications using relative distance between entities. Notably, UWB utilizes double-sided, two-way ranging between devices and provides for highly precise positioning, within 10 cm of ranging accuracy in as little as three degrees of precision through time-of-flight (ToF) and angle-of-arrival (AoA) measurements at up to 100 m through the use of impulse radio communications in the 6-10 GHz frequency range. The positioning is an accurate and secure technology using the scrambled timestamp sequence (STS), cryptographically secure pseudo-random number generation, and other features of the UWB PHY.

### BRIEF DESCRIPTION OF THE DRAWINGS

Implementations of the techniques for object and environment dimensioning based on UWB radios are described with reference to the following Figures. The same numbers may be used throughout to reference like features and components shown in the Figures:

FIG. 1 illustrates example devices and features for object and environment dimensioning based on UWB radios in accordance with one or more implementations as described herein.

FIGS. 2 and 3 illustrate examples of environment mapping generated for object and environment dimensioning based on UWB radios in accordance with one or more implementations as described herein.

FIG. 4 illustrates an example of an environment depth map generated for object and environment dimensioning based on UWB radios in accordance with one or more implementations as described herein.

FIG. 5 illustrates examples of UWB tags and devices location association in accordance with one or more implementations described herein.

FIG. 6 illustrates an example cloud-based system in which aspects and features of object and environment dimensioning based on UWB radios can be implemented.

FIGS. 7-10 illustrate example methods for object and environment dimensioning based on UWB radios in accordance with one or more implementations of the techniques described herein.

FIG. 11 illustrates various components of an example device that can be used to implement the techniques for object and environment dimensioning based on UWB radios as described herein.

### DETAILED DESCRIPTION

Implementations of techniques for object and environment dimensioning based on ultra-wideband (UWB) radios are described, and provide techniques that can be implemented by any type of computing devices, such as smart devices, mobile devices (e.g., cellular phones, tablet devices, smartphones, wireless devices), consumer electronics, smart home automation devices, and the like. Generally, UWB-enabled smart devices, such as smartphones and home automation devices, can be used to determine spatial awareness that provides features implemented in smart homes and buildings with access control, security, location-based services, and peer-to-peer applications.

In aspects of the techniques for object and environment dimensioning based on UWB radios, a system includes UWB radios associated with respective devices in an environment. Generally, smart devices can be objects in an environment that may be implemented with a UWB radio for UWB communications. In other implementations, UWB tags include a UWB radio and can be located for association with respective objects in an environment, to include non-UWB-enabled devices, and each UWB tag can be identified with a digital label indicative of the association with one or more of the tagged objects. As described herein, an object in an environment can include tagged objects, as well as non-tagged objects, and may be any type of a smart device, mobile device, wireless device, electronic device, or a non-communication-enabled, static object or device.

In implementations, one or more of the UWB radios may be UWB tags located for association with a respective object, smart device, mobile device, wireless device, electronic device, and/or media device. A UWB tag may be located for association with a smart device, media device, or other object in the environment, and the UWB tag can determine an identity of the associated device based on a Bluetooth MAC ADDR and/or other device identifying information communicated from the smart device, media device, or other object. Generally, the tagging of a respective object (to include devices) in the environment is a function of identifying a position or location of the object in the environment, and attaching a semantic label to the UWB radio of a UWB tag that is located and associated with the respective object.

The described techniques can utilize UWB ranging data, such as time-of-flight (ToF), angle-of-arrival (AoA), and/or time-difference-of-arrival (TDoA), as well as Wi-Fi and/or Bluetooth RSSI measurements, and optionally camera imaging, to determine UWB radio and UWB tag locations in the environment. The UWB precise location positioning capabilities is utilized to enable location detection of the UWB radios and UWB tags at particular locations in the environment, which can then be used to enhance the wireless and digital experience in a smart home environment by utilizing the precise and secure location positioning features.

The system also includes a mapping module, such as implemented by a computing device in the environment, and the mapping module can determine the location of each of the UWB radios implemented in UWB-enabled devices, and the location of each tagged object in the environment based on a position of a UWB radio associated with the tagged object. The mapping module is also implemented to determine a location of each of the non-tagged objects in the environment, such as based on the positions of the UWB radios in the environment. The mapping module can determine the location of each of the UWB radios and/or UWB tags in the environment, and determine relative positions of each of the UWB radios and/or UWB tags with respect to each other. The mapping module obtains UWB ranging data received from the UWB radios and/or UWB tags via in-band session exchanges with a UWB radio, and determines the location and the relative position of each of the UWB radios and/or UWB tags in the environment based on the UWB ranging data.

The mapping module can then determine dimensions of the environment and the objects based on the location and a relative position of each tagged object and non-tagged object in the environment. For example, the mapping module can triangulate the mobile device and two of the UWB tags to determine the length and width of the environment. The mapping module can also determine an initial elevation of the mobile device and a subsequent elevation of the mobile device, and then determine a volume of the environment based on the area of the environment and an elevation delta between the initial elevation and the subsequent elevation of the mobile device.

In implementations, a camera device in the environment can be used to capture an image of the environment, or a region of the environment. An object detection module can then be utilized to identify the objects in the environment from the captured image, and the mapping module can determine the location and the relative position of each of the tagged objects and the non-tagged objects in the environment based on the UWB radios, the UWB tags, and/or the identified objects in the environment. In implementations, the mapping module can determine the dimensions of an identified object in the environment based on the location and the relative position of the identified object and UWB ranging data received from one or more of the UWB radios and/or UWB tags in the environment. Additionally, the mapping module can generate an environment mapping, such as a location association map that is generally a floor plan of a building, such as in a smart home that includes the objects, media devices, and/or smart devices locations, with the floor plan including positions of the walls of the building as determined from the captured image.

In implementations, the mapping module can also generate a depth map showing the relative location of the objects and devices in the environment. The depth map can be generated by comparing spatial distances between the identified objects and devices appearing in the captured environment image and UWB ranging data received from one or more of the UWB radios and/or UWB tags in the environment. As an application implemented by a computing device, the mapping module has an associated user interface that is generated to display the depth map on a display screen of the device, such as on a mobile device for user viewing in the environment. Further, the mapping module can be used to determine the location of a misplaced object in the environment based on the UWB ranging data received from the UWB radio and/or UWB tag associated with the misplaced object. The location of an object or device in the environment can be determined utilizing the UWB ranging data, given that UWB time-of-flight (ToF), angle-of-arrival (AoA), and/or time-difference-of-arrival (TDoA) provides a vector of both range and direction. The mapping module can then generate the user interface showing the location of the misplaced object in the environment.

While features and concepts of the described techniques for object and environment dimensioning based on UWB radios can be implemented in any number of different devices, systems, environments, and/or configurations, implementations of the techniques for object and environment dimensioning based on UWB radios are described in the context of the following example devices, systems, and methods.

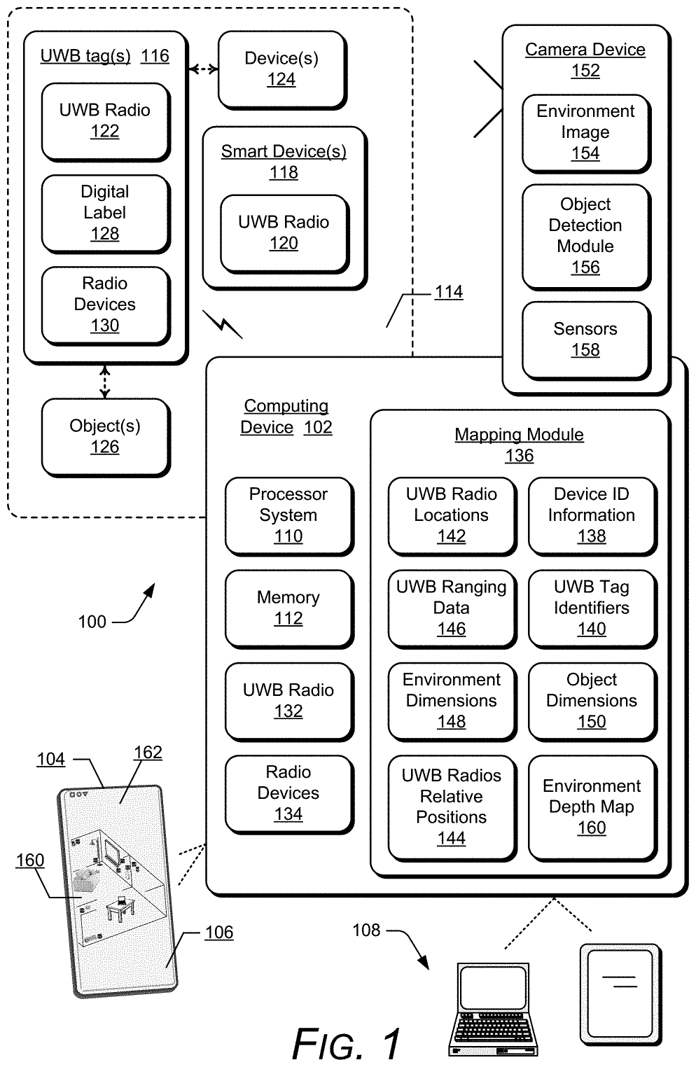

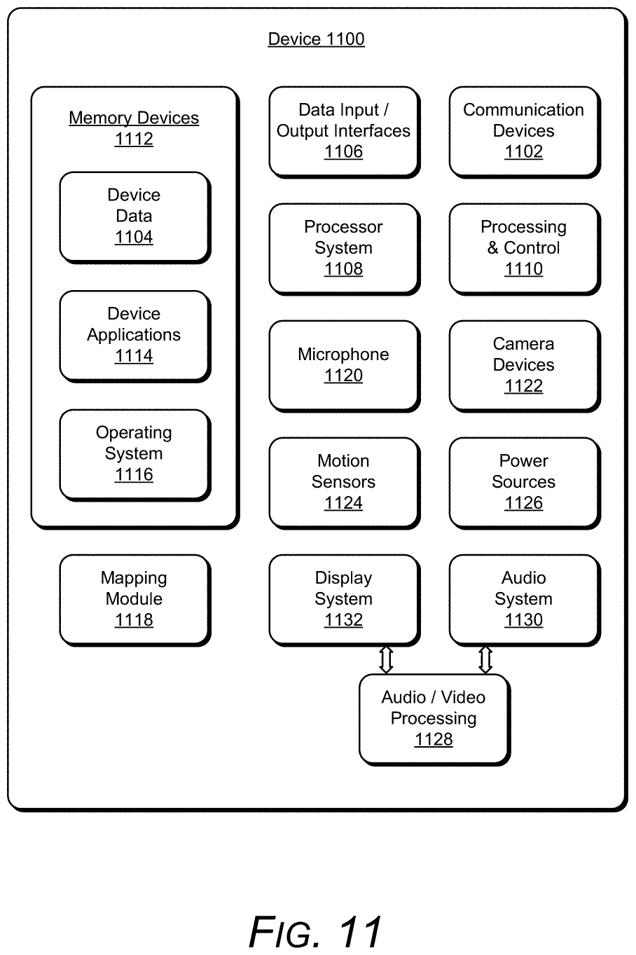

FIG. 1 illustrates an example system 100 for object and environment dimensioning based on UWB radios, as described herein. Generally, the system 100 includes a computing device 102, which can be utilized to implement features and techniques of the object and environment dimensioning. In this example system 100, the computing device 102 may be a wireless device 104 with a display screen 106, such as a smartphone, mobile phone, or other type of mobile wireless device. Alternatively or in addition, the system 100 can include the computing device 102 as any type of an electronic, computing, and/or communication device 108, such as a computer, a laptop device, a desktop computer, a tablet, a wireless device, a camera device, a smart device, a media device, a smart display, a smart TV, a smart appliance, a home automation device, and so forth. The computing device 102 can be implemented with various components, such as a processor system 110 and memory 112, as well as any number and combination of different components as further described with reference to the example device shown in FIG. 11. For example, the wireless device 104 can include a power source to power the device, such as a rechargeable battery and/or any other type of active or passive power source that may be implemented in an electronic, computing, and/or communication device.

In implementations, the wireless device 104 may be communicatively linked, generally by wireless connection, to UWB radios of UWB tags and/or to other UWB-enabled devices for UWB communication in an environment 114. Generally, the environment 114 can include the computing device 102, the wireless device 104, objects, the UWB tags 116, and other UWB-enabled devices implemented with a UWB radio for communication utilizing UWB, as well as any number of the other types of electronic, computing, and/or communication devices 108 described herein. The wireless UWB communications in the environment 114 are similar between the UWB tags and/or other UWB-enabled devices, such as the smart devices 118 in the environment. The UWB tags 116 can be placed in the environment proximate each of the objects and other devices, and then labeled with a functional name to indicate a UWB tag association with a particular object and/or device. Given the angular precision and centimeter accurate ranging that UWB provides, location detection of UWB radios and UWB tags 116 at particular locations in the environment 114 can be used to enhance the wireless and digital experience in a smart home environment.

In this example system 100, smart devices 118 may be enabled for UWB communications with an embedded UWB radio 120. Alternatively, a UWB tag 116 having a UWB radio 122 may be associated with any other types of devices 124 that are not UWB-enabled in the environment 114. Similarly, a UWB tag 116 may be associated with any type of object 126 in the environment, to include any type of a smart device, media device, mobile device, wireless device, electronic device, as well as associated with static object or device that is not enabled for wireless communications. For example, the UWB tags 116 can be positioned and located in the environment 114 for association with respective devices and/or objects, and each UWB tag can be identified with a digital label 128 indicative of the association with one or more of the objects 126 and/or devices 124 in the environment. For example, an object 126 may be a smart TV in a home environment, and the digital label 128 of the UWB tag 116 indicates “smart TV” as the identifier of the UWB tag association. Similarly, an object 126 may be a floor lamp in the home environment, and the digital label 128 of the UWB tag 116 indicates “floor lamp” as the identifier of the UWB tag association. Notably, the tagging is a function of identifying a position of an object 126 or a device 124, and attaching a semantic label (e.g., “TV”, “lamp”, “chair”, etc.) to the UWB radio 122 of the UWB tag 116 that is located and associated with a respective object or device.

In some instances, one or more smart devices 118, the other devices 124, and/or the objects 126 in the environment 114 may already be UWB-enabled with a UWB radio 120 for wireless communication with the other devices and with the UWB tags 116 in the environment. The wireless UWB communications for mapping the smart devices 118, the objects 126, and/or devices 124 in the environment 114 are similar between the UWB tags 116 and/or UWB-enabled smart devices in the environment. A network of the UWB tags 116 in the environment 114 can discover and communicate between themselves and/or with a control device or controller logic that manages the devices, the smart devices, and the UWB tags in the environment.

In implementations, a UWB tag 116 can be used at a fixed location to facilitate accurate location, mapping, and positioning of inanimate objects and/or areas in the environment 114, such as positioning the UWB tag 116 in a corner of the environment or on a blank wall in a home environment. Generally, the object 126 associated with the UWB tag 116 would then be the portion of the blank wall proximate the UWB tag. Given the known location of the blank wall in the home environment, a user may then overlay augmented reality (AR) information on the blank wall and interact with the digital world that is anchored by the UWB tag 116, even though the wall is inherently not an electronic or other type of smart device. Similarly, the UWB tags 116 in the environment 114 can allow for an AR-guided user experience, such as to locate a missing item or other misplaced device. For example, if a user loses or misplaces a smartphone or smart watch, the precision of location detection provided by the system of UWB tags 116 can guide a user to the location of the missing item in the environment.

The UWB protocol is designed to utilize out-of-band communications that use low-power, wireless protocols for UWB device discovery and UWB session configuration, such as via Bluetooth or Bluetooth Low Energy (BLE), which uses less power than if a UWB radio was used alone. Additionally, using BLE for UWB out-of-band communications provides for a large network effect given the number of devices that are already BLE-enabled. Because BLE is able to receive and decode advertising packets, the UWB tags 116 placed in the environment 114 proximate a device, for example, can determine the nearest Bluetooth MAC ADDR and likely an indication of the device name of the nearby device. When the nearest device name is not advertised, the UWB tag can check against the BD ADDR that is already known on the computing device 102, which is also particularly useful if privacy settings are enabled and an identity resolving key is not available on the UWB Tag.

Alternatively or in addition to a UWB tag 116 receiving address and device identifying information from nearby devices (to include smart devices), and then identifying the device 124 that is located nearest to the UWB tag, the computing device 102 can communicate with the UWB tags 116 and the UWB radios of other devices in the environment, and receive Bluetooth or BLE advertised communications from the UWB tags and UWB radios of the other devices. The computing device 102 may be a centralized controller and/or a mobile device in the environment that correlates a UWB tag 116 with a nearby device 124 based on RSSI measurements of the Bluetooth or BLE advertised communications from the UWB tags and devices. For example, the computing device 102 can receive advertised signals from a UWB tag 116 or other UWB-enabled device, and compare the signal path loss from the received signals to determine that the UWB tag and device are proximate each other in the environment 114 based on similar signal path loss.

In aspects of the described features for object and environment dimensioning based on UWB radios, user interaction can be minimized or eliminated as the UWB tags are implemented to automate identification and labeling, such as by using Bluetooth or BLE communications and/or captured images. For example, when a UWB tag 116 is located for association with a device 124 in the environment 114, the UWB tag can determine an identity of the device based on a Bluetooth MAC ADDR and/or other device identifying information communicated from the device. Additionally, the UWB tag 116 can utilize received Wi-Fi or Bluetooth RSSI measurements in conjunction with the UWB positioning information to generate and sort a list of nearby devices, and select the MAC ADDR of the device closest to the UWB tag. Further, in an environment that includes the computing device 102, such as a mobile phone, smartphone, or other wireless device that has a network association with the device 124, the UWB tag 116 that is located for association with the device 124 in the environment can receive an identity of the device from the computing device.

In this example system 100, a UWB tag 116 is generally representative of any UWB tag or device with embedded UWB in the environment 114, and can include various radios for wireless communications with other devices and/or with the other UWB tags in the environment. For example, the UWB tag 116 can include a UWB radio 122 and other radio devices 130, such as a Bluetooth radio, a Wi-Fi radio, and/or a global positioning system (GPS) radio implemented for wireless communications with other devices and with the UWB tags 116 in the environment 114. The computing device 102 also includes various radios for wireless communication with the smart devices 118, the other devices 124, and/or with the UWB tags 116 in the environment. For example, the computing device 102 includes a UWB radio 132 and other radio devices 134, such as a Bluetooth radio, a Wi-Fi radio, and a GPS radio implemented for wireless communications with other devices and with the UWB tags 116 in the environment 114.

In implementations, the computing device 102, smart devices 118, other devices 124, and/or the UWB tags 116 may include any type of positioning system, such as a GPS transceiver or other type of geo-location device, to determine the geographical location of a UWB tag, device, and/or the computing device. Notably, any of the devices described herein, to include components, modules, services, computing devices, camera devices, and/or the UWB tags, can share the GPS data between any of the devices, whether they are GPS-hardware enabled or not. Although the resolution of global positioning is not as precise as the local positioning provided by UWB, the GPS data that is received by the GPS-enabled devices can be used for confirmation that the devices are all generally located in the environment 114, which is confirmed by the devices that are also UWB-enabled and included in the environment mapping. Other objects and devices, such as a smart TV, smart home appliance, lighting fixture, or other static, non-communication-enabled objects, may not be GPS-hardware enabled, yet are included in the environment mapping based on the UWB tag and UWB radio associations with the respective objects and devices. The GPS location of these other objects and devices can be determined based on their relative position in the environment 114 and their proximity to the GPS-enabled devices. Accordingly, changes in location of both GPS-enabled devices and non-GPS devices and objects can be tracked based on global positioning and local positioning in the environment.

The computing device 102 can also implement any number of device applications and/or modules, such as any type of a messaging application, communication application, media application, and/or any other of the many possible types of device applications or application modules. In this example system 100, the computing device 102 implements a mapping module 136, which may include independent processing, memory, and/or logic components functioning as a computing and/or electronic device integrated with the computing device 102. Alternatively or in addition, the mapping module 136 can be implemented in software, in hardware, or as a combination of software and hardware components. In this example, the mapping module 136 is implemented as a software application or module, such as executable software instructions (e.g., computer-executable instructions) that are executable with a processor (e.g., with the processor system 110) of the computing device 102 to implement the techniques and features for object and environment dimensioning based on UWB radios, as described herein.

As a software application or module, the mapping module 136 can be stored on computer-readable storage memory (e.g., the memory 112 of the device), or in any other suitable memory device or electronic data storage implemented with the module. Alternatively or in addition, the mapping module 136 may be implemented in firmware and/or at least partially in computer hardware. For example, at least part of the module may be executable by a computer processor, and/or at least part of the module may be implemented in logic circuitry.

As described above, a UWB tag 116 that is located for association with a device 124 in the environment 114 can determine an identity of the device based on a Bluetooth MAC ADDR and/or other device identifying information communicated from the smart device. Generally, the UWB tags 116 can scan to receive device identifying information 138 communicated from nearby devices 124 in the environment. The device identifying information 138 can be communicated via Bluetooth or BLE from the devices as a device name, a Bluetooth MAC ADDR, and a received signal strength indication (RSSI). The UWB tag 116 can identify the device 124 that is located nearest to the UWB tag based on the device identifying information 138 received from the devices, and generate an ordered list of the devices based on the device identifying information to identify the device that is located nearest to the UWB tag. Additionally, the mapping module 136 implemented by the computing device 102 can receive the device identifying information 138 communicated from the devices 124 in the environment, as well as the UWB tag identifiers 140 communicated from the UWB tags 116 in the environment.

In other implementations, and as described above, the computing device 102 can communicate with the UWB tags 116, the UWB radios 120, 122, and with other devices 124 in the environment 114, receiving Bluetooth or BLE advertised communications from the UWB tags and devices. The computing device implements the mapping module 136, which can correlate a UWB tag 116 with a nearby device 124 based on RSSI measurements of the Bluetooth or BLE advertised communications from the UWB tags and devices. For example, the computing device 102 can receive advertised signals from the UWB tags 116, the UWB radios 120, 122, and/or the devices 124, and the mapping module 136 compares the signal path loss from the received signals to determine which of the UWB tags, UWB radios, and devices are proximate each other based on similar signal path loss. The mapping module 136 can then associate a UWB tag with a nearby device, and communicate the association back to the UWB tag, such as via in-band UWB communications.

As noted above, the example system 100 includes the UWB tags 116 located for association with respective devices 124 and objects 126 in the environment 114, and the objects can include both tagged objects, as well as non-tagged objects. In aspects of the described techniques for object and environment dimensioning based on UWB radios, the mapping module 136 implemented by the computing device 102 can determine the location of each of the tagged objects and devices in the environment 114 based on a position of a UWB radio 120, 122 associated with a tagged object or device. The mapping module 136 can also determine a location of each of the objects, devices, and non-tagged objects based on the UWB radio locations 142 in the environment.

In implementations, the mapping module 136 can determine the UWB radio location 142 of each of the UWB radios 120, 122 in the environment 114, and determines the relative positions 144 of each of the UWB radios with respect to each other. The mapping module 136 can obtain UWB ranging data 146, such as time-of-flight (ToF), angle-of-arrival (AoA), and/or time-difference-of-arrival (TDoA) data, as received from the UWB radios 120, 122 via in-band session exchanges with the UWB radio 132 of the computing device 102. The ToF is a two-way communication between a UWB tag 116 and another device, while TDoA is one-way communication, where the UWB tag 116 communicates a signal but does not need to wait for a reply, such as from the computing device 102. The mapping module 136 may also receive and utilize other communication data that is shared over Bluetooth or BLE, such as relative position data shared between UWB devices. The mapping module 136 can then determine the location 142 and the relative position 144 of each of the UWB tags 116 and UWB radios in the environment 114 based on the UWB ranging data 146.

The mapping module 136 is implemented to determine environment dimensions 148 and object dimensions 150 of the objects in the environment 114 based on the location and a relative position of each tagged object and non-tagged object in the environment. For example, the mapping module 136 can triangulate the wireless device 104 and two of the UWB radios 122 of the UWB tags 116 to determine a length and a width of the environment. The mapping module 136 can also determine an initial elevation of the wireless device 104 and a subsequent elevation of the wireless device in the environment 114, and then determine a volume of the environment based on the area of the environment and an elevation delta between the initial elevation and the subsequent elevation of the wireless device.

Although the mapping module 136 is shown and described as being implemented by the computing device 102 in the environment 114, any of the other smart devices in the environment may implement the mapping module 136 and/or an instantiation of the mapping module. For example, the system 100 includes a camera device 152, which may be an independent electronic, computing, and/or communication device in the environment 114, and the camera device 152 can implement the mapping module 136. Similarly, a control device or controller logic in the environment 114 can implement the mapping module, as well as a UWB tag 116 may implement the mapping module 136 in the environment.

In this example system 100, the camera device 152 may be implemented as a security camera, indoor environment camera, a doorbell camera, and the like. Generally, the camera device 152 may be implemented with any number and combination of the components described with reference to the computing device 102, where the camera device 152 can include an integrated UWB radio, as well as independent processing, memory, and/or logic components functioning as a computing and camera device. Alternatively, the camera device 152 may be implemented as a component of the computing device 102, such as in a mobile phone or other wireless device with one or more camera devices to facilitate image capture.

The camera device 152, such as any type of a security camera, indoor environment camera, a doorbell camera, or a camera device of the computing device 102, can be utilized to further implement the techniques for object and environment dimensioning based on UWB radios. The camera device 152 can be used to capture an image 154 of the environment 114 (or a region of the environment), and the camera device implements an object detection module 156 utilized to identify the smart devices 118, other devices 124, and/or the objects 126 in the environment from the captured image. Similar to the mapping module 136, the object detection module 156 may include independent processing, memory, and/or logic components functioning as a computing and/or electronic device integrated with the camera device 152 and/or with the computing device 102. Alternatively or in addition, the object detection module 156 can be implemented in software, in hardware, or as a combination of software and hardware components. In this example, the object detection module 156 is implemented as a software application or module, such as executable software instructions (e.g., computer-executable instructions) that are executable with a device processor and stored on computer-readable storage memory (e.g., on memory of the device).

In implementations, the camera device 152 may also include various sensors 158, such as an infra-red (IR) time-of-flight (TOF) sensor that can be used in conjunction with the described techniques utilizing UWB. An advantage of utilizing UWB with the UWB tags 116 over conventional IR TOF is that UWB can still be used to perform ranging when occluded by objects, such as a wall or object in the environment 114 that blocks IR and for objects that may not be viewable in the captured environment images. However, IR TOF of the camera device 152 may still be utilized in conjunction with the techniques described herein for object and environment dimensioning based on the UWB tags.

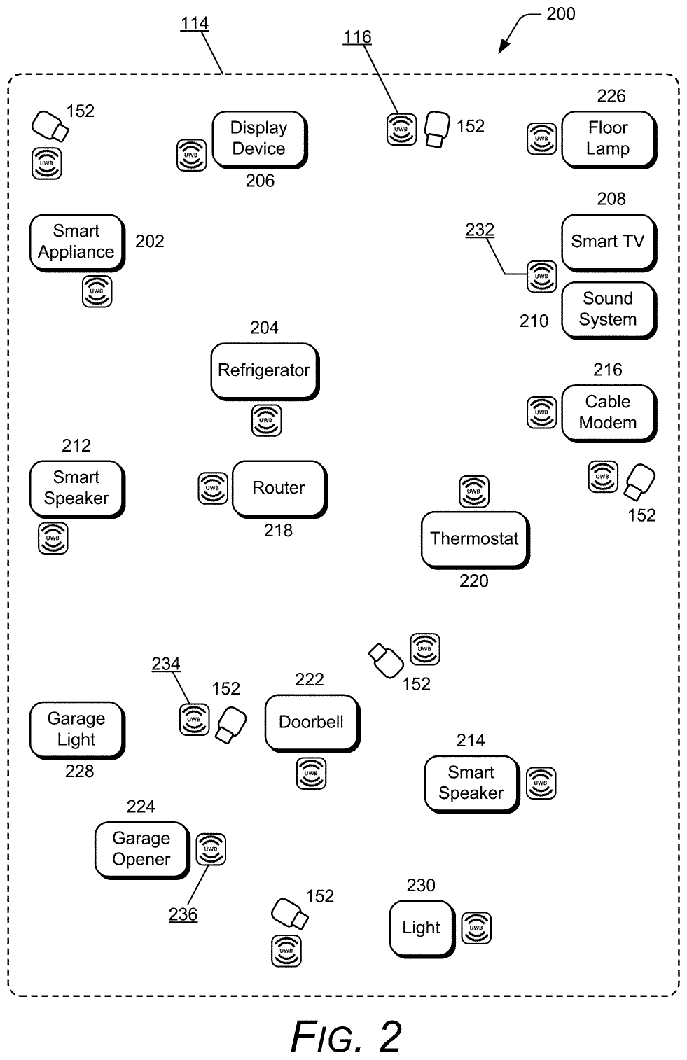

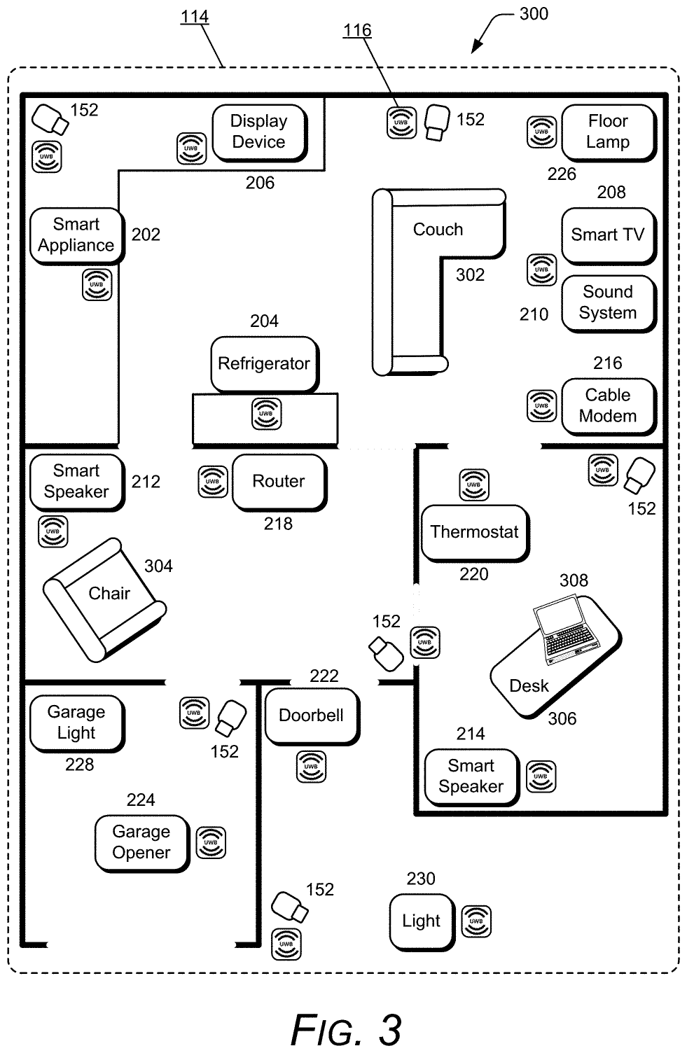

In aspects of the object and environment dimensioning, the object detection module 156 can be used to identify the objects 126 (e.g., to include the smart devices 118 and other devices 124) in the environment 114 from the captured environment image 154. The mapping module 136 can then determine the location and the relative position of each of the tagged objects and the non-tagged objects in the environment based on the UWB radios 120, 122 and the identified objects and devices in the environment. In implementations, the mapping module 136 can determine the object dimensions 150 of an identified object in the environment based on the location and the relative position of the identified object and the UWB ranging data 146 received from one or more of the UWB radios in the environment. Additionally, the mapping module 136 can generate an environment mapping, such as a location association map, that is generally a floor plan of a building or smart-home environment, including the locations of the objects and/or the smart devices in the building. The floor plan can be generated in a three-dimension coordinate system of the environment 114 including positions of the walls of the building as determined from the captured image. An example of a location association map showing the location of the devices and/or the objects in the environment 114 is further shown and described with reference to FIGS. 2 and 3.

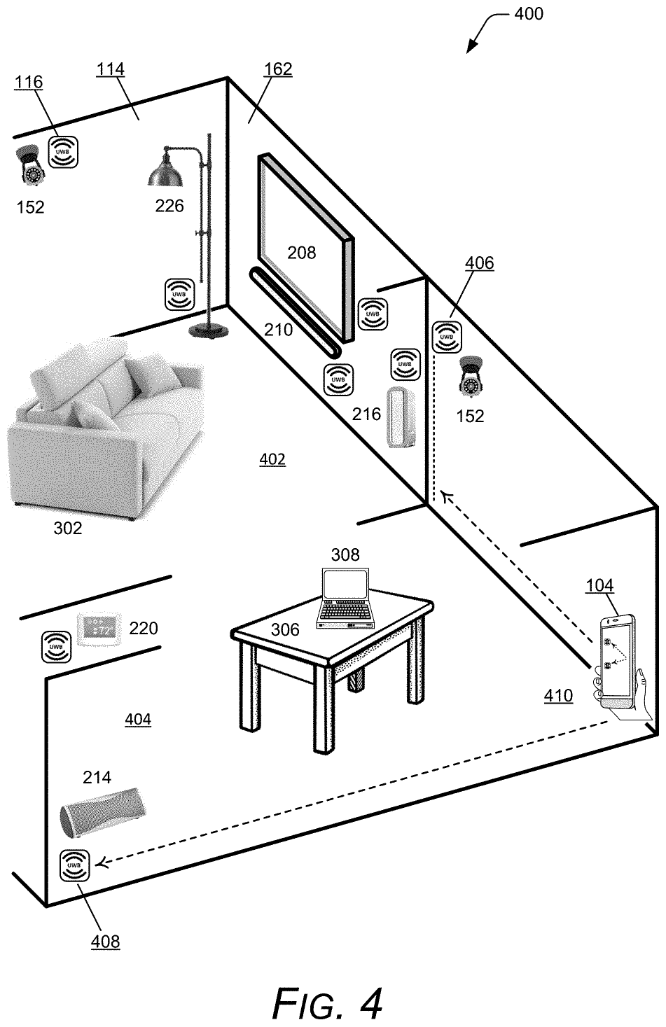

In implementations, the mapping module 136 can also generate an environment depth map 160 showing the relative location of the objects 126 and devices in the environment. As described herein, an object 126 in the environment may be any type of a smart device, media device, mobile device, wireless, and/or electronic device, as well as a non-communication-enabled, static object or device. The environment depth map 160 can be generated by comparing spatial distances between the objects identified by the object detection module 156 that appear in the captured environment image 154 and the UWB ranging data 146 received from one or more of the UWB tags 116 and/or UWB radios in the environment. As noted above, the UWB radios 120, 122 can be used to perform ranging when occluded by objects, such as a wall or object in the environment 114 that blocks IR and for objects that may not be viewable in the captured environment images. However, IR TOF implemented as a sensor 158 of the camera device 152 may still be utilized in conjunction with the techniques described herein for object and environment dimensioning based on the UWB tags. An example of an environment depth map showing the location of the smart devices 118, the objects 126, and/or the other devices 124, in the environment 114 is further shown and described with reference to FIG. 4.

As a device application implemented by the computing device 102, the mapping module 136 may have an associated application user interface 162 that is generated and displayed for user interaction and viewing, such as on the display screen 106 of the wireless device 104. Generally, an application user interface 162, or any other type of video, image, graphic, and the like is digital image content that is displayable on the display screen 106 of the wireless device 104. The mapping module 136 can generate and initiate to display the environment depth map 160 in the user interface 162 on the display screen 106 of the wireless device 104 for user viewing in the environment. Further, the mapping module 136 can be used to determine the location of a misplaced object 126 in the environment 114 based on the UWB ranging data 146 received from the UWB radio 122 of the UWB tag 116 that is associated with the misplaced object. The mapping module 136 can then generate the user interface 162 showing the location of the misplaced object in the environment.

FIG. 2 illustrates an example 200 of environment mapping showing the location of smart devices and/or objects in the environment 114, such as a location association map generated by the mapping module 136 implemented by the computing device 102, as shown and described with reference to FIG. 1. In this example 200 of the environment 114, the position of each of the devices and other objects is shown relative to each other in the environment, as determined based on the precise location positioning capabilities of UWB utilizing the UWB tags 116. The environment 114 includes examples of the smart devices 118 (to include media devices), such as a smart appliance 202 and refrigerator 204, a display device 206, a smart TV 208 and sound system 210, smart speakers 212, 214, a cable modem 216 and router 218, a thermostat 220 and smart doorbell 222, and a garage door opener 224. The environment 114 also includes examples of other objects 126, such as a floor lamp 226, a garage light 228, and an outdoor light 230. The environment 114 also includes several examples of camera devices 152 positioned at various locations throughout the environment.

In this example 200 of environment mapping, the relative locations of the smart devices, media devices, objects, and other devices to each other are shown in the environment 114, without walls of the building, such as in the home environment. In an aspect of the environment mapping, it should be noted that one UWB tag can be associated with more than one object and/or device in the environment, and can be labeled accordingly to provide the user a meaningful identifier that represents the combined objects and/or devices. For example, the UWB tag 232 is positioned for association with both the smart TV 208 and the sound system 210, and the UWB tag may be identified as “entertainment center.”

In another aspect of the environment mapping, two or more of the UWB tags can be used to associate and locate objects that are not tagged in their spatial location. For example, the garage light 228 does not have an associated UWB tag. However, the two UWB tags 234, 236 (e.g., in the garage) can be used to determine the relative position of the garage light 228 in the environment for spatial awareness. The associated camera device 152 may also be used to capture an environment image 154 of the region (e.g., in the garage), and the environment image is used to further determine the relative position of the garage light 228 in the environment for spatial awareness.

FIG. 3 similarly illustrates an example 300 of environment mapping showing the location of the smart devices, objects, and/or other devices in the environment 114, such as generated by the mapping module 136 implemented by the computing device 102, as shown and described above with reference to FIGS. 1 and 2. Further, in this example 300 of a building environment, such as in a smart home implementation, the mapping module 136 generates the environment mapping of the smart devices 118, other devices 124, and/or the other objects 126 in the environment 114 based on the identified objects and/or the smart devices in the environment, as determined by the object detection module 156 from captured environment images 154. The various camera devices 152 positioned at locations throughout the environment 114 can be used to capture the environment images 154 of the different regions of the environment.

The mapping module 136 generates the environment mapping as a floor plan of the building, including the locations of the objects 126, smart devices 118, and/or other devices 124 in the building, with the floor plan including positions of walls of the building as determined from the captured environment images 154. The environment mapping shows the position of each of the devices and objects relative to each other, as well as the walls of the environment, which provides a more detailed spatial context. In addition to the smart devices 118, objects 126, and other devices 124 shown in the environment mapping in FIG. 2, this example 300 also includes other objects determined from the captured environment images 154. For example, the mapped environment also includes the location and position of a couch 302, a chair 304, and a desk 306 in various rooms of the home environment.

Additionally, a UWB-enabled laptop computing device 308 has been added into the environment, and the laptop computing device communicates via a UWB radio with the UWB tags 116 and other UWB-enabled devices in the environment. The laptop computing device 308 can be implemented as an example of the computing device 102, which is shown and described with reference to FIG. 1. Notably, the laptop computing device 308 can implement the mapping module 136 to facilitate mapping the objects and/or devices in the environment 114, based on the locations and relative positions of each of the UWB tags. The wireless UWB communications for mapping objects and/or devices in the environment 114 are similar between the UWB tags and/or UWB-embedded smart devices in the environment.

FIG. 4 illustrates an example 400 of an environment depth map 160 generated for object and environment dimensioning based on UWB radios, as described herein. The single-elevation floorplan in the examples of environment mapping shown in FIGS. 2 and 3 may also be generated by the mapping module 136 as a multi-elevation building or home environment. Notably, the system of UWB tags 116 and UWB radios also provides for z-elevation differentiation using the precise location positioning capabilities of UWB for a three-dimension coordinate mapping of a multi-elevation environment. In this example 400, a portion of the environment mapping shown in FIG. 3 is recreated and shown as the environment depth map 160.

The portion of the environment 114 shown in the environment depth map 160 shows the relative locations of the smart devices 118, objects 126, and other devices 124 to each other in various rooms of the home environment. For example, a living area 402 includes a camera device 152, the smart TV 208 and sound system 210, the cable modem 216, the floor lamp 226, and the respective UWB tags 116 and/or UWB radios that are associated with the devices and objects. Similarly, an office area 404 includes a camera device 152, the smart speaker 214, the desk 306, the laptop computing device 308, and the respective UWB tags 116 and/or UWB radios that are associated with the objects and devices.

This example 400 of the environment depth map 160 also illustrates environment dimensioning utilizing existing UWB tags 116 and/or placing additional UWB tags in the environment 114. For example, dimensions of the office area 404 can be measured using the precision accuracy of UWB based on the UWB tags 406, 408 in two corners of the room, along with the wireless device 104 communicating with the UWB radios 122 of the UWB tags from another corner of the room at 410 to determine the length and width of the room. Additionally, by utilizing more of the UWB tags 116 in the environment 114 and/or by altering the placement of the wireless device 104, the area and volume of regions in the environment can be determined, as well as measurements and dimensions of objects in the environment. Taken in conjunction with environment images 154 captured by one or more of the camera devices 152, surface areas of walls and floors can be determined, such as for determining the square footage for flooring and painting projects, as well as for virtual modeling and/or remodeling applications by placing objects in a viewfinder of the wireless device 104 to assess their appearance in the environment.

Additionally, AR overlays and enhancements can be generated for an AR-enhanced depth map as a virtual model of the environment 114, which can be displayed in an enhanced user interface on the display screen 106 of the wireless device 104. The object and environment dimensioning and measurements of objects 126 can be used to provide calibration inputs to the AR-enhanced depth map. In aspects of the described features, the environment depth map 160 in conjunction with an environment image 154 captured by a camera device 152 can also be used to facilitate locating a misplaced item in the environment, such as with an AR-guided user experience to locate a missing item or other misplaced device. The mapping module 136 can then generate the user interface 162 showing the location of the misplaced object in the environment depth map 160 on the display screen 106 of the wireless device 104.

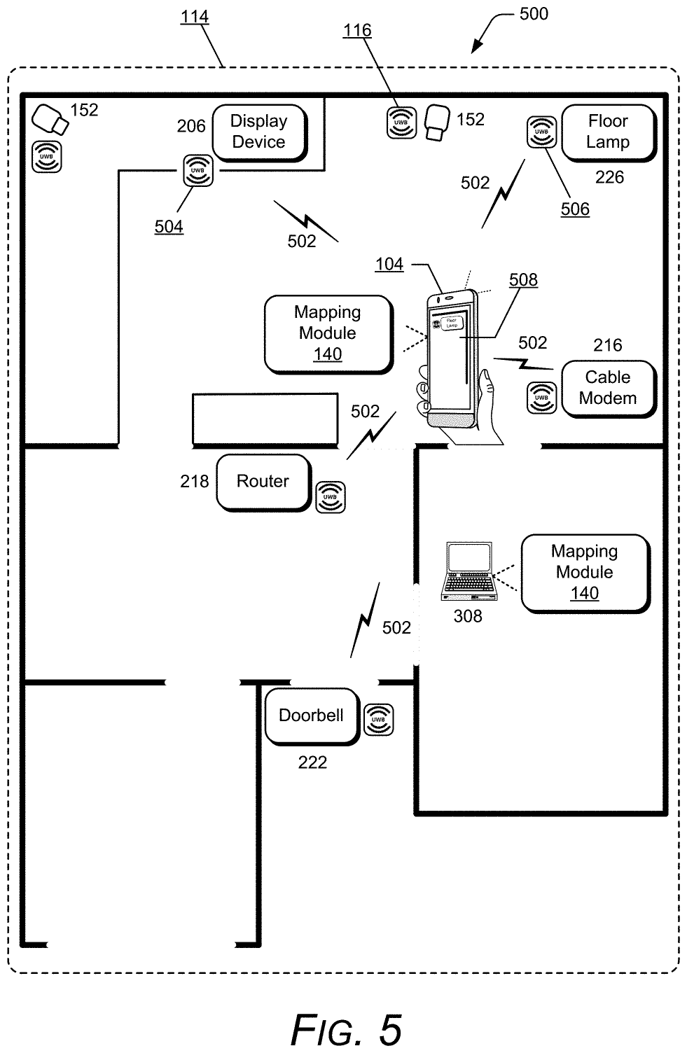

FIG. 5 illustrates examples 500 of UWB tags and devices location association in accordance with one or more implementations of object and environment dimensioning based on UWB radios, as described herein. The example of the environment 114 shown in FIG. 3 is further illustrated with additional example features of the mapping module 136, as implemented in a computing device 102, such as the wireless device 104 (e.g., a mobile phone or other device) in the environment. In these examples 500, the wireless device 104 communicates via the UWB radio 132 with the UWB tags 116 and other UWB radios in the environment. Similarly, the wireless device 104 can also communicate via a Bluetooth radio and/or a Wi-Fi radio with the smart devices 118 and/or the other devices 124 in the environment, such as the display device 206, the cable modem 216, the router 218, the smart doorbell 222, and the laptop computing device 308, to name a few. Although these examples 500 are described with reference to the wireless device 104 implementing the mapping module 136, it should be noted that the laptop computing device 308 may also implement the mapping module 136, and operate independently or in conjunction with the instantiation of the mapping module as implemented by the wireless device.

In an example use case, a user can start the mapping module 136 as an application on the wireless device 104 (e.g., a mobile phone), as well as place the UWB tags 116 for association with the smart devices 118, objects 126, and/or other devices 124 in the environment 114. An operational mode of the UWB tags 116 can be enabled, as well as an advertising mode, discoverable mode, or other type of operational mode initiated on the smart devices 118 and/or other devices 124. The UWB tags 116, as well as the wireless device 104, can then scan for the Bluetooth or BLE advertising and/or other identifiable RF packets advertised as messages from the devices. The mapping module 136 can initiate to query the UWB tags 116 for a BLE MAC ADDR report, device name, RSSIs, and any other type of device identifying information.

Additionally, the UWB tags 116 can generate an ordered list of proximate devices 124 and/or smart devices 118 based on RSSI and/or reported transmission power to assess which of the smart devices is the closest to a particular UWB tag. The mapping module 136 implemented by the wireless device 104 can also compare the UWB tag reports against its own database of device identifying information 138 and UWB tag identifiers 140. Additionally, the mapping module 136 can then compare the signal path loss of the signals received from the UWB tags and other UWB-enabled devices to determine which of the UWB tags and smart devices are proximate each other based on similar signal path loss. Notably, a user can override any of the UWB tag and device determined associations, either by a UWB tag itself or by the mapping module, and the user can then designate which one of the UWB tags is associated with a particular device or object.

In implementations, some reported BLE MAC ADDRs may be random addresses due to the BLE privacy feature, and are unresolvable by a UWB tag 116 without an identity resolving key that is otherwise available on the wireless device 104, given that the wireless device has been previously paired with the devices using random addressing. For these obscure BLE MAC ADDRs due to random addresses, or unpaired devices not transmitting identifiable information, the wireless device 104 can disambiguate, communicate the appropriate address to the UWB tag 116, and update the database for the UWB tag identifiers 140. A UWB tag identifier 140 can be generated automatically by the mapping module 136, or optionally, a user of the device may be prompted via the user interface 162 to approve or change the generated UWB tag identifiers 140 and designated associations with objects and/or smart devices. For further disambiguation of the UWB tags 116 associated with the smart devices 118, objects 126, and/or other devices 124 in the environment 114, a camera device 152 can be used to capture the environment image 154. The object detection module 156 can then determine the location of the devices and objects in the environment, and the location information used by the mapping module 136 to generate the environment mapping.

The mapping module 136 receives (via wireless device 104) the Bluetooth or BLE advertised communications 502 from the UWB tags 116 and other UWB radios of devices in the environment 114. The mapping module 136 can then correlate a UWB tag 116 with a nearby device based on RSSI measurements of the Bluetooth or BLE advertised communications 502 from the UWB tags and UWB radios of the devices. For example, the wireless device 104 can receive advertised signals from a UWB tag 504 and the smart display device 206, and the mapping module 136 compares the signal path loss from the received signals to determine that the UWB tag 504 and the smart display device 206 are proximate each other based on similar signal path loss. The mapping module 136 can then associate the UWB tag 504 with the nearby smart display device 206, and communicate the association back to the UWB tag 504, such as via in-band UWB communications.

In a similar implementation, the mapping module 136 receives (via wireless device 104) the Bluetooth or BLE advertised communications 502 from a UWB tag 506 that is proximate an object, such as the floor lamp 226 in the environment 114. The mapping module 136 can utilize the received signals and a captured environment image 154 to determine that the UWB tag 506 is proximate the floor lamp 226, associate the UWB tag 506 with the nearby object, and communicate the association back to the UWB tag 506, such as via in-band UWB communications. As noted above, a user of the wireless device 104 can override any of the UWB tag and device determined associations by the mapping module, and the user can designate any one of the UWB tags as being associated with a particular device or other object.

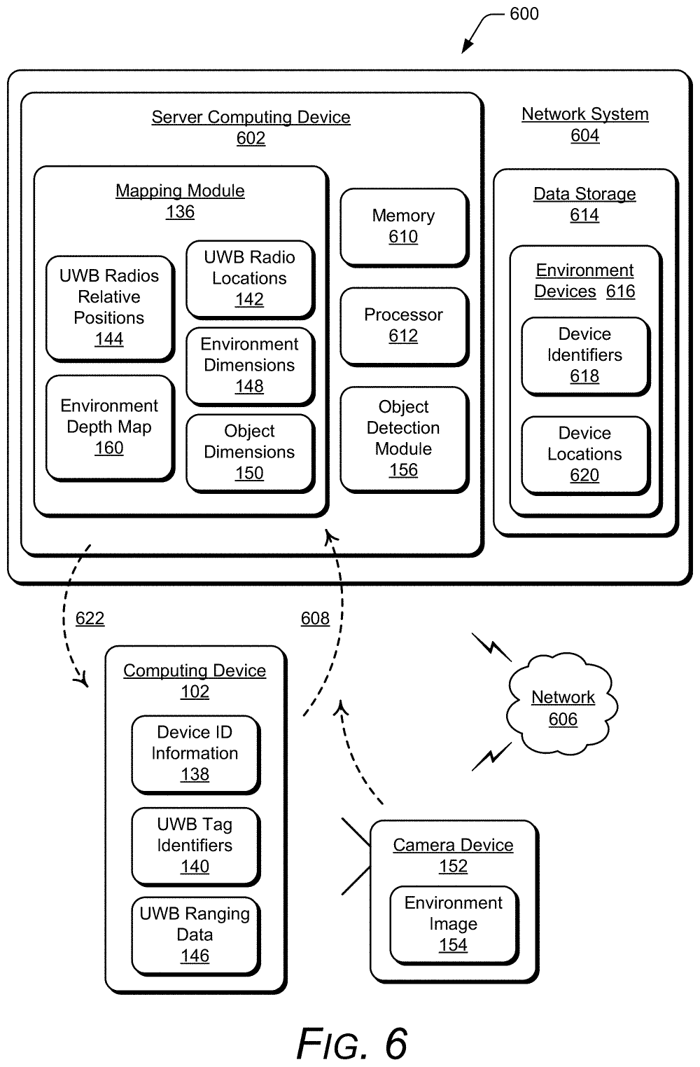

FIG. 6 illustrates an example of a cloud-based system 600 in which aspects and features of object and environment dimensioning based on UWB radios can be implemented. The example system 600 includes the computing device 102 and the camera device 152, such as shown and described with reference to FIG. 1. In this example system 600, the computing device 102 and the camera device 152 are implemented to access and communicate with a server computing device 602 of a network system 604, such as via a communication network 606. The server computing device 602 implements an instantiation of the mapping module 136 to determine the locations 142 of each of the UWB radios 120, 122 in the environment 114, determine the relative positions 144 of each of the UWB radios with respect to each other, and generate environment mapping. The mapping module 136 is also implemented to determine the environment dimensions 148 and the object dimensions 150 of the objects in the environment 114 based on the location and a relative position of each tagged object and non-tagged object in the environment. The server computing device 602 can also implement an instantiation of the object detection module 156 to identify the objects, smart devices, and/or other devices in regions of the environment from the environment images 154 captured by the camera devices 152 positioned in the environment.

The camera device 152 can upload the environment images 154 to the network system 604 via the communication network 606. Similarly, the computing device 102 can upload the received device identifying information 138, the UWB tags identifiers 140, the UWB ranging data 146, and any other type of environment data to the network system 604 for processing and evaluation by the mapping module 136 that is implemented by the server computing device 602. The upload of data from the camera device 152 and/or from the computing device 102 to the network system may be automatically controlled by the respective devices, or optionally, initiated by a user of the devices. The network system 604 can receive the uploaded environment data as inputs to the mapping module 136 from the computing device 102 and/or from the camera device 152, as indicated at 608 via the communication network 606.

Any of the devices, applications, modules, servers, and/or services described herein can communicate via the communication network 606, such as for data communication between the computing device 102 and the network system 604, and for data communication between the camera device 152 and the network system. The communication network 606 can be implemented to include a wired and/or a wireless network. The communication network 606 can also be implemented using any type of network topology and/or communication protocol, and can be represented or otherwise implemented as a combination of two or more networks, to include IP-based networks and/or the Internet. The communication network 606 may also include mobile operator networks that are managed by a mobile network operator and/or other network operators, such as a communication service provider, mobile phone provider, and/or Internet service provider.

In this example cloud-based system 600, the network system 604 is representative of any number of cloud-based access sites that provide a service and/or from which data and information is available, such as via the Internet, for on-line and/or network-based access. The network system 604 can be accessed on-line, and includes the server computing device 602, which is representative of one or more hardware server devices (e.g., computing devices) that may be implemented at the network system. The server computing device 602 includes memory 610 and a processor 612, and may include any number and combination of different components as further described with reference to the example device shown in FIG. 11.

In this example cloud-based system 600, the server computing device 602 implements the mapping module 136 and/or the object detection module 156, such as in software, in hardware, or as a combination of software and hardware components, generally as shown and described with reference to FIG. 1. In this example, the mapping module 136 and the object detection module 156 are implemented as software applications or modules, such as executable software instructions (e.g., computer-executable instructions) that are executable with a processing system (e.g., the processor 612) of the server computing device 602 to implement the techniques of object and environment dimensioning based on UWB radios. The mapping module 136 and the object detection module 156 can be stored on computer-readable storage media, such as any suitable memory device (e.g., the device memory 610) or on electronic data storage implemented in the server computing device 602 and/or at the network system 604.

The network system 604 may include multiple data storage, server devices, and applications, and can be implemented with various components as further described with reference to the example device shown in FIG. 11. The network system 604 also includes data storage 614 that may be implemented as any suitable memory or electronic data storage for network-based data storage. The data storage 614 is utilized at the network system 604 to maintain any type of environment data and device information, such as in a database of environment devices 616, with associated device identifiers 618 and device locations 620 in the environment. The device locations 620 may also include Global Positioning System (GPS) data that indicates the locations of the objects 126, smart devices 118, and/or other devices 124 in the environment 114, such as in a smart home environment.

The data storage 614 can also be utilized at the network system 604 to maintain any type of the uploaded environment data, such as the uploaded environment images 154 and/or the various UWB radios locations 142 in the environment 114, the UWB radios relative positions 144 with respect to each other, and the environment depth map 160 determined by the mapping module 136, as shown and described with reference to FIGS. 1-5. The environment and device information determined by the mapping module 136 and/or by the object detection module 156 can then be communicated as feedback from the network system 604 to the computing device 102, as indicated at 622 via the communication network 606.

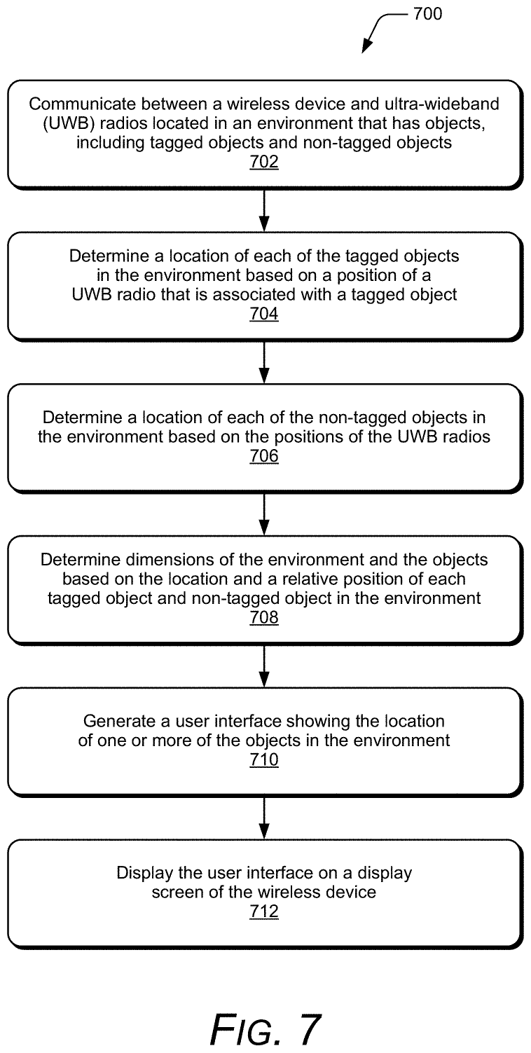

Example methods 700, 800, 900, and 1000 are described with reference to respective FIGS. 7-10 in accordance with implementations for object and environment dimensioning based on UWB radios. Generally, any services, components, modules, methods, and/or operations described herein can be implemented using software, firmware, hardware (e.g., fixed logic circuitry), manual processing, or any combination thereof. Some operations of the example methods may be described in the general context of executable instructions stored on computer-readable storage memory that is local and/or remote to a computer processing system, and implementations can include software applications, programs, functions, and the like. Alternatively or in addition, any of the functionality described herein can be performed, at least in part, by one or more hardware logic components, such as, and without limitation, Field-programmable Gate Arrays (FPGAs), Application-specific Integrated Circuits (ASICs), Application-specific Standard Products (ASSPs), System-on-a-chip systems (SoCs), Complex Programmable Logic Devices (CPLDs), and the like.

FIG. 7 illustrates example method(s) 700 for object and environment dimensioning based on UWB radios, and is generally described with reference to a mapping module implemented by a computing device. The order in which the method is described is not intended to be construed as a limitation, and any number or combination of the described method operations can be performed in any order to perform a method, or an alternate method.

At 702, a wireless device communicates with ultra-wideband (UWB) radios located in an environment that has objects, including tagged objects and non-tagged objects. For example, the wireless device 104 (e.g., an example of the computing device 102) is communicatively linked, generally by wireless connection, to the UWB radios 122 of the UWB tags 116 and/or to other UWB-enabled devices for UWB communication in the environment 114. Generally, the environment 114 includes the wireless device 104, smart devices 118, the UWB tags 116, and other UWB-enabled devices implemented with a UWB radio for communication utilizing UWB, as well as any number of the other types of electronic, computing, and/or communication devices 108 described herein. The wireless UWB communications in the environment 114 are similar between the UWB tags and/or UWB-embedded devices, such as the smart devices 118, in the environment. The wireless device 104 can communicate with the UWB radios 122 of the UWB tags 116, as well as with the UWB-enabled smart devices 118 and other devices 124, in the environment 114, receiving Bluetooth or BLE advertised communications from the UWB radios, the smart devices, and other devices.

At 704, a location of each of the tagged objects in the environment is determined based on a position of a UWB radio that is associated with a tagged object. For example, the mapping module 136 implemented by the computing device 102 receives advertised signals from the UWB radios 120, 122 of the UWB tags 116 and the smart devices 118, and the mapping module 136 compares the signal path loss from the received signals to determine which of the UWB radios and smart devices are proximate each other based on similar signal path loss. The mapping module 136 determines the location of each of the tagged objects in the environment 114 based on a position of a UWB radio associated with a tagged object, such as based on UWB ranging data and/or GPS data received from one or more of the UWB radios in the environment.

At 706, a location of each of the non-tagged objects in the environment is determined based on the positions of the UWB radios. For example, the mapping module 136 implemented by the computing device 102 determines a location of each of the non-tagged objects based on the UWB radio locations 142 in the environment, such as based on the UWB ranging data and/or GPS data received from one or more of the UWB radios 120 in the environment.

At 708, dimensions of the environment and the objects are determined based on the location and a relative position of each tagged object and non-tagged object in the environment. For example, the mapping module 136 implemented by the wireless device 104 (e.g., an example of the computing device 102) determines the dimensions of the environment 114 by triangulating the wireless device and two UWB radios, such as the UWB radios 122 of two UWB tags 116, to determine a length and a width of the environment. The mapping module 136 can also determine an initial elevation of the wireless device 104 and a subsequent elevation of the wireless device in the environment 114, and then determine a volume of the environment based on the area of the environment and an elevation delta between the initial elevation and the subsequent elevation of the wireless device.

At 710, a user interface is generated showing the location of one or more of the objects in the environment, and at 712, the user interface is displayed on a display screen of the wireless device. For example, the mapping module 136 implemented by the wireless device 104 generates the associated application user interface 162 that is displayed for user interaction and viewing, such as on the display screen 106 of the wireless device. The user interface 162 can be generated to show the dimensions of the environment 114 based on measurements determined from the location and relative position of one or more of the UWB radios in the environment. Generally, an application user interface 162, or any other type of video, image, graphic, and the like is digital image content that is displayable on the display screen 106 of the wireless device 104. For a smart home environment, the mapping module 136 can generate and initiate to display the environment depth map 160 in the user interface 162 on the display screen 106 of the wireless device 104 for user viewing in the environment, showing the locations of the tagged objects and the non-tagged objects in the environment.

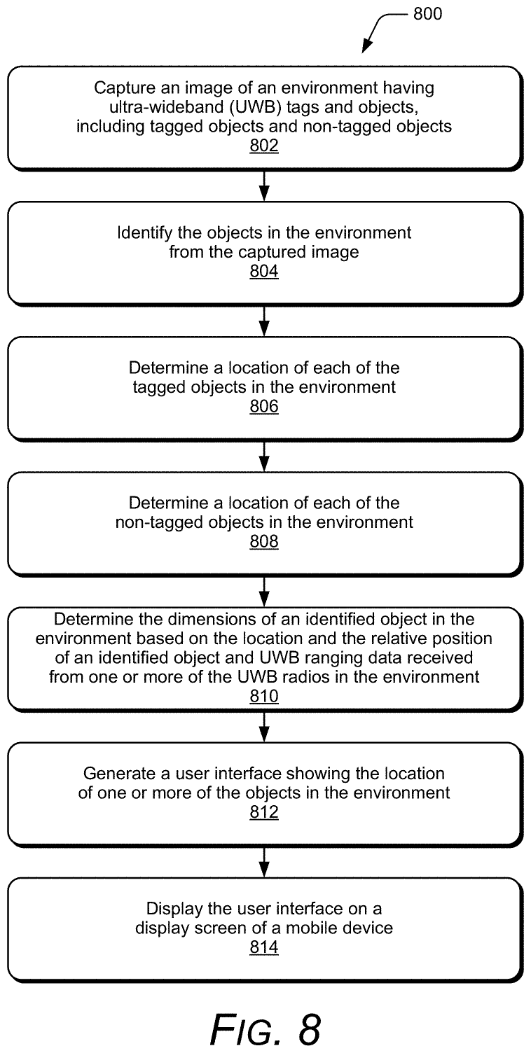

FIG. 8 illustrates example method(s) 800 for object and environment dimensioning based on UWB radios, and is generally described with reference to a mapping module implemented by a computing device. The order in which the method is described is not intended to be construed as a limitation, and any number or combination of the described method operations can be performed in any order to perform a method, or an alternate method.

At 802, an image is captured of an environment having ultra-wideband (UWB) tags and objects, including tagged objects and non-tagged objects. For example, the camera device 152 captures an image 154 of the environment 114 (or a region of the environment), which includes the UWB tags 116 and objects, including tagged objects and non-tagged objects. As described herein, an object in an environment may be any type of a smart device, mobile device, wireless device, electronic device, or a non-communication-enabled, static object or device.

At 804, the objects in the environment are identified from the captured image. For example, the object detection module 156 implemented by the camera device 152 is utilized to identify the objects 126, the smart devices 118, and/or other devices 124 in the environment from the captured image.

At 806, a location of each of the tagged objects in the environment is determined, and at 808, a location of each of the non-tagged objects in the environment is determined. For example, the mapping module 136 implemented by the computing device 102 determines the location and the relative position of each of the tagged objects and the non-tagged objects in the environment 114 based on the UWB radios and the identified objects and devices in the environment. Additionally, the mapping module 136 can determine the location and the relative position of each of the tagged objects and the non-tagged objects in the environment 114 based on identified objects from a captured environment image 154 and the UWB ranging data 146 received from one or more of the UWB radios in the environment.

At 810, the dimensions of an identified object in the environment is determined based on the location and the relative position of an identified object and UWB ranging data received from one or more of the UWB radios in the environment. For example, the mapping module 136 implemented by the computing device 102 determines the object dimensions 150 of an identified object in the environment based on the location and the relative position of the identified object and the UWB ranging data 146 received from one or more of the UWB radios in the environment.

At 812, a user interface is generated showing the location of one or more of the objects in the environment, and at 814, the user interface is displayed on a display screen of a wireless device. For example, the mapping module 136 implemented by the wireless device 104 (e.g., an example of the computing device 102) generates the associated application user interface 162 that is displayed for user interaction and viewing, such as on the display screen 106 of the wireless device. The user interface 162 can be generated to show the dimensions of the environment 114 based on measurements determined from the location and relative position of one or more of the UWB radios in the environment. For a smart home environment, the mapping module 136 can generate and initiate to display the environment depth map 160 in the user interface 162 on the display screen 106 of the wireless device 104 for user viewing in the environment, showing the locations of the tagged objects and the non-tagged objects in the environment.

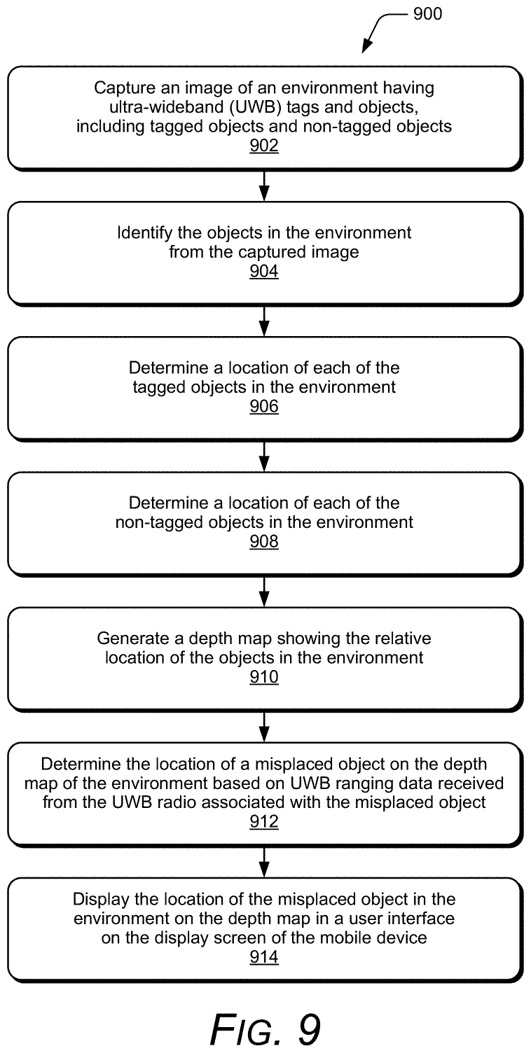

FIG. 9 illustrates example method(s) 900 for object and environment dimensioning based on UWB radios, and is generally described with reference to a mapping module implemented by a computing device. The order in which the method is described is not intended to be construed as a limitation, and any number or combination of the described method operations can be performed in any order to perform a method, or an alternate method.

At 902, an image is captured of an environment having ultra-wideband (UWB) tags and objects, including tagged objects and non-tagged objects. For example, the camera device 152 captures an image 154 of the environment 114 (or a region of the environment), which includes the UWB tags 116 and objects, including tagged objects and non-tagged objects. As described herein, an object in an environment may be any type of a smart device, mobile device, wireless device, electronic device, or a non-communication-enabled, static object or device.

At 904, the objects in the environment are identified from the captured image. For example, the object detection module 156 implemented by the camera device 152 is utilized to identify the objects 126, the smart devices 118, and/or other devices 124 in the environment from the captured image.

At 906, a location of each of the tagged objects in the environment is determined, and at 908, a location of each of the non-tagged objects in the environment is determined. For example, the mapping module 136 implemented by the computing device 102 determines the location and the relative position of each of the tagged objects and the non-tagged objects in the environment 114 based on the UWB radios and the identified objects in the environment. Additionally, the mapping module 136 can determine the location and the relative position of each of the tagged objects and the non-tagged objects in the environment 114 based on identified objects from a captured environment image 154 and the UWB ranging data 146 received from one or more of the UWB radios in the environment.

At 910, a depth map is generated showing the relative location of the objects in the environment. For example, the mapping module 136 implemented by the computing device 102 generates an environment depth map 160 showing the relative location of the objects 126 (e.g., to include electronic and other smart devices) in the environment. The environment depth map 160 can be generated by comparing spatial distances between the objects identified by the object detection module 156 that appear in the captured environment image 154 and the UWB ranging data 146 received from one or more of the UWB radios in the environment.

At 912, the location of a misplaced object is determined on the depth map of the environment based on UWB ranging data received from the UWB radio associated with the misplaced object. For example, the mapping module 136 implemented by the computing device 102 determines the location of a misplaced object 126 in the environment 114 based on the UWB ranging data 146 received from the UWB radio that is associated with the misplaced object.

At 914, the location of the misplaced object in the environment is displayed on the depth map in a user interface on the display screen of the wireless device. For example, the mapping module 136 implemented by the computing device 102 generates the user interface 162 displaying the environment depth map 160 and showing the location of the misplaced object in the environment.

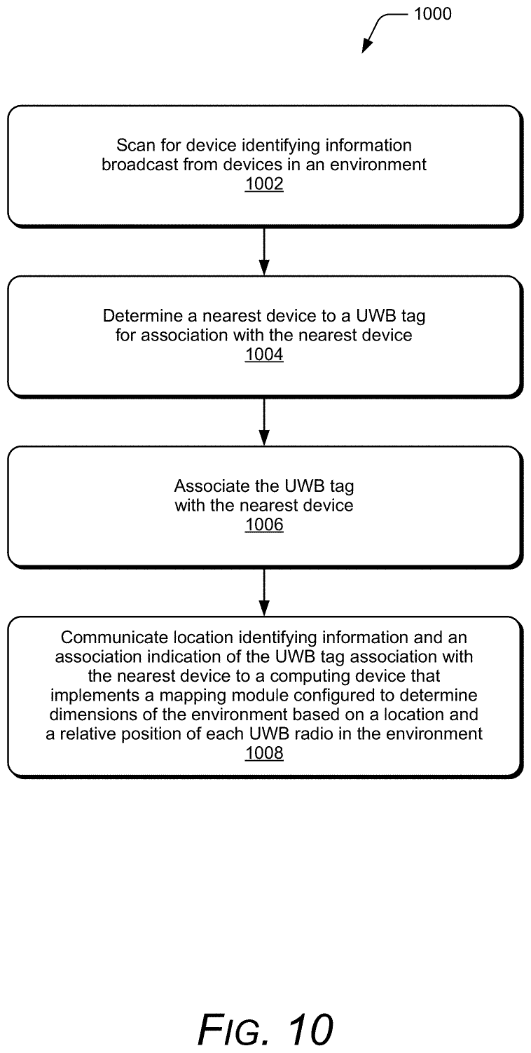

FIG. 10 illustrates example method(s) 1000 for object and environment dimensioning based on UWB radios. The order in which the method is described is not intended to be construed as a limitation, and any number or combination of the described method operations can be performed in any order to perform a method, or an alternate method.

At 1002, device identifying information that is broadcast from devices in an environment is scanned for by UWB tags. For example, one or more UWB tags 116 are located for association with respective devices 124 in the environment 114, and each UWB tag is identified with a digital label 128 indicative of the association with one of the devices. The one or more UWB tags 116 scan for the device identifying information 138 broadcast from the devices. In implementations, the one or more UWB tags 116 receive the device identifying information communicated as Bluetooth or Bluetooth Low Energy (BLE) from the devices 124 as a device name, a Bluetooth MAC ADDR, received signal strength indications (RSSI), and/or any other type of device identifying information.

At 1004, a nearest device to a UWB tag is determined for association of the UWB tag with the nearest device. For example, each of the one or more UWB tags 116 can determine a nearest device 124 to a UWB tag based on a received signal strength indications (RSSI) associated with the device identifying information 138 received from the nearest device. At 1006, the UWB tag is associated with the nearest device. For example, each of the one or more UWB tags 116 can associate itself with the nearest device 124, as determined based on the received device identifying information 138.

At 1008, location identifying information and an association indication of the UWB tag association with the nearest device are communicated to a computing device that implements a mapping module configured to determine dimensions of the environment based on a location and a relative position of each UWB radio in the environment. For example, each of the one or more UWB tags 116 can then communicate its association indication of the UWB tag association with the nearest device to a computing device 102 that implements the mapping module 136, which determines dimensions of the environment 114 based on a location and a relative position of each of the UWB radios (e.g., the UWB radios 122 of the UWB tags) in the environment.

FIG. 11 illustrates various components of an example device 1100, which can implement aspects of the techniques and features for object and environment dimensioning based on UWB radios, as described herein. The example device 1100 can be implemented as any of the devices described with reference to the previous FIGS. 1-10, such as any type of a wireless device, mobile device, mobile phone, flip phone, client device, companion device, paired device, display device, tablet, computing, communication, entertainment, gaming, media playback, and/or any other type of computing and/or electronic device. For example, the computing device 102, the camera device 152, and/or a UWB tag 116 described with reference to FIGS. 1-10 may be implemented as the example device 1100.

The example device 1100 can include various, different communication devices 1102 that enable wired and/or wireless communication of device data 1104 with other devices. The device data 1104 can include any of the various devices data and content that is generated, processed, determined, received, stored, and/or communicated from one computing device to another. Generally, the device data 1104 can include any form of audio, video, image, graphics, and/or electronic data that is generated by applications executing on a device. The communication devices 1102 can also include transceivers for cellular phone communication and/or for any type of network data communication.

The example device 1100 can also include various, different types of data input/output (I/O) interfaces 1106, such as data network interfaces that provide connection and/or communication links between the devices, data networks, and other devices. The I/O interfaces 1106 can be used to couple the device to any type of components, peripherals, and/or accessory devices, such as a computer input device that may be integrated with the example device 1100. The I/O interfaces 1106 may also include data input ports via which any type of data, information, media content, communications, messages, and/or inputs can be received, such as user inputs to the device, as well as any type of audio, video, image, graphics, and/or electronic data received from any content and/or data source.

The example device 1100 includes a processor system 1108 of one or more processors (e.g., any of microprocessors, controllers, and the like) and/or a processor and memory system implemented as a system-on-chip (SoC) that processes computer-executable instructions. The processor system 1108 may be implemented at least partially in computer hardware, which can include components of an integrated circuit or on-chip system, an application-specific integrated circuit (ASIC), a field-programmable gate array (FPGA), a complex programmable logic device (CPLD), and other implementations in silicon and/or other hardware. Alternatively or in addition, the device can be implemented with any one or combination of software, hardware, firmware, or fixed logic circuitry that may be implemented in connection with processing and control circuits, which are generally identified at 1110. The example device 1100 may also include any type of a system bus or other data and command transfer system that couples the various components within the device. A system bus can include any one or combination of different bus structures and architectures, as well as control and data lines.

The example device 1100 also includes memory and/or memory devices 1112 (e.g., computer-readable storage memory) that enable data storage, such as data storage devices implemented in hardware which can be accessed by a computing device, and that provide persistent storage of data and executable instructions (e.g., software applications, programs, functions, and the like). Examples of the memory devices 1112 include volatile memory and non-volatile memory, fixed and removable media devices, and any suitable memory device or electronic data storage that maintains data for computing device access. The memory devices 1112 can include various implementations of random-access memory (RAM), read-only memory (ROM), flash memory, and other types of storage media in various memory device configurations. The example device 1100 may also include a mass storage media device.

The memory devices 1112 (e.g., as computer-readable storage memory) provide data storage mechanisms, such as to store the device data 1104, other types of information and/or electronic data, and various device applications 1114 (e.g., software applications and/or modules). For example, an operating system 1116 can be maintained as software instructions with a memory device 1112 and executed by the processor system 1108 as a software application. The device applications 1114 may also include a device manager, such as any form of a control application, software application, signal-processing and control module, code that is specific to a particular device, a hardware abstraction layer for a particular device, and so on.

In this example, the device 1100 includes a mapping module 1118 that implements various aspects of the described features and techniques for object and environment dimensioning based on UWB radios. The mapping module 1118 can be implemented with hardware components and/or in software as one of the device applications 1114, such as when the example device 1100 is implemented as the computing device 102 and/or the camera device 152 described with reference to FIGS. 1-10. An example of the mapping module 1118 includes the mapping module 136 that is implemented by the computing device 102, such as a software application and/or as hardware components in the computing device. In implementations, the mapping module 1118 may include independent processing, memory, and logic components as a computing and/or electronic device integrated with the example device 1100.

The example device 1100 can also include a microphone 1120 and/or camera devices 1122, as well as motion sensors 1124, such as may be implemented as components of an inertial measurement unit (IMU). The motion sensors 1124 can be implemented with various sensors, such as a gyroscope, an accelerometer, and/or other types of motion sensors to sense motion of the device. The motion sensors 1124 can generate sensor data vectors having three-dimensional parameters (e.g., rotational vectors in x, y, and z-axis coordinates) indicating location, position, acceleration, rotational speed, and/or orientation of the device. The example device 1100 can also include one or more power sources 1126, such as when the device is implemented as a wireless device and/or mobile device. The power sources may include a charging and/or power system, and can be implemented as a flexible strip battery, a rechargeable battery, a charged super-capacitor, and/or any other type of active or passive power source.

The example device 1100 can also include an audio and/or video processing system 1128 that generates audio data for an audio system 1130 and/or generates display data for a display system 1132. The audio system and/or the display system may include any types of devices or modules that generate, process, display, and/or otherwise render audio, video, display, and/or image data. Display data and audio signals can be communicated to an audio component and/or to a display component via any type of audio and/or video connection or data link. In implementations, the audio system and/or the display system are integrated components of the example device 1100. Alternatively, the audio system and/or the display system are external, peripheral components to the example device.

Although implementations for object and environment dimensioning based on UWB radios have been described in language specific to features and/or methods, the appended claims are not necessarily limited to the specific features or methods described. Rather, the specific features and methods are disclosed as example implementations for object and environment dimensioning based on UWB radios, and other equivalent features and methods are intended to be within the scope of the appended claims. Further, various different examples are described and it is to be appreciated that each described example can be implemented independently or in connection with one or more other described examples. Additional aspects of the techniques, features, and/or methods discussed herein relate to one or more of the following:

A system, comprising: objects in an environment, the objects including tagged objects and non-tagged objects; ultra-wideband (UWB) radios associated with respective tagged objects in the environment; a mapping module implemented at least partially in hardware and configured to: determine a location of each of the tagged objects in the environment based on a position of the UWB radio associated with a tagged object; determine a location of each of the non-tagged objects in the environment based on the positions of the UWB radios; determine dimensions of the environment and the objects based on the location and a relative position of each tagged object and non-tagged object in the environment.

Alternatively or in addition to the above described system, any one or combination of: one or more of the UWB radios are UWB tags located for association with the respective tagged objects. The system further comprising a wireless device configured to implement the mapping module in the environment, the mapping module configured to triangulate the wireless device and two of the UWB radios to determine a length and a width of the environment. The mapping module is configured to: determine an initial elevation of the wireless device and a subsequent elevation of the wireless device; and determine a volume of the environment based on an area of the environment and an elevation delta between the initial elevation and the subsequent elevation of the wireless device. The system further comprising: a camera device configured to capture an image of the environment; an object detection module configured to identify the objects in the environment from the captured image; and wherein the mapping module is configured to determine the location and the relative position of each of the tagged objects and the non-tagged objects in the environment based on the UWB radios and the identified objects in the environment. The mapping module is configured to determine the dimensions of an identified object in the environment based on the location and the relative position of the identified object and UWB ranging data received from one or more of the UWB radios in the environment. The system further comprising a wireless device configured to: implement the mapping module to generate a user interface showing the location of one or more of the objects in the environment; and initiate to display the user interface on a display screen of the wireless device. The mapping module is configured to generate the user interface showing the dimensions of the environment based on measurements determined from the location and relative position of one or more of the UWB radios in the environment. The mapping module is configured to: determine the location of a misplaced object in the environment based on UWB ranging data received from the UWB radio associated with the misplaced object; and generate the user interface showing the location of the misplaced object in the environment. The system further comprising: a wireless device configured to implement the mapping module in the environment; a camera device configured to capture an image of the environment; an object detection module configured to identify the objects in the environment from the captured image; and the mapping module is configured to: generate a depth map showing the relative location of one or more of the objects in the environment, the depth map generated by comparing spatial distances between the identified objects appearing in the captured image and UWB ranging data received from one or more of the UWB radios in the environment; and generate a user interface to display the depth map on a display screen of the wireless device.

A method, comprising: communicating between a wireless device and ultra-wideband (UWB) radios located in an environment that has objects, including tagged objects and non-tagged objects; determining a location of each of the tagged objects in the environment based on a position of a UWB radio that is associated with a tagged object; determining a location of each of the non-tagged objects in the environment based on the positions of the UWB radios; determining dimensions of the environment and the objects based on the location and a relative position of each tagged object and non-tagged object in the environment.

Alternatively or in addition to the above described method, any one or combination of: the dimensions of the environment are determined by triangulating the wireless device and two of the UWB radios to determine a length and a width of the environment. The dimensions of the environment are determined by: determining an initial elevation of the wireless device and a subsequent elevation of the wireless device; and determining a volume of the environment based on an area of the environment and an elevation delta between the initial elevation and the subsequent elevation of the wireless device. The method further comprising: capturing an image of the environment; identifying the objects in the environment from the captured image; and wherein the location and the relative position of each of the tagged objects and the non-tagged objects in the environment are determined based on the UWB radios and the identified objects in the environment. The method further comprising determining the dimensions of an identified object in the environment based on the location and the relative position of the identified object and UWB ranging data received from one or more of the UWB radios in the environment. The method further comprising: generating a user interface showing the location of one or more of the objects in the environment; and displaying the user interface on a display screen of the wireless device. The user interface is generated to show the dimensions of the environment based on measurements determined from the location and relative position of one or more of the UWB radios in the environment. The method further comprising: capturing an image of the environment; identifying the objects in the environment from the captured image utilizing object detection; generating a depth map showing the relative location of one or more of the objects in the environment, the depth map generated by comparing spatial distances between the identified objects appearing in the captured image and UWB ranging data received from one or more of the UWB radios in the environment; and wherein the user interface is generated to display the depth map on a display screen of the wireless device.

A system, comprising: one or more ultra-wideband (UWB) tags located for association with respective devices in an environment, the one or more UWB tags each configured to: scan for device identifying information broadcast from the devices; determine a nearest device to a UWB tag for association of the UWB tag with the nearest device; and communicate location identifying information and an association indication of the UWB tag association with the nearest device to a computing device that implements a mapping module configured to determine dimensions of the environment based on a location and a relative position of each UWB radio in the environment. The mapping module is configured to determine the dimensions of each of the devices based on the location and the relative position of each UWB radios in the environment.

1. A system, comprising:
objects in an environment, the objects including tagged objects and non-tagged objects;
ultra-wideband (UWB) radios associated with respective tagged objects in the environment;
a mapping module implemented at least partially in hardware and configured to:
determine a location of each of the tagged objects in the environment based on a position of the UWB radio associated with a tagged object;
determine a location of each of the non-tagged objects in the environment based on the positions of the UWB radios;
determine dimensions of the environment and the objects based on the location and a relative position of each tagged object and non-tagged object in the environment.

2. The system as recited in claim 1, wherein one or more of the UWB radios are UWB tags located for association with the respective tagged objects.

3. The system as recited in claim 1, further comprising a wireless device configured to implement the mapping module in the environment, the mapping module configured to triangulate the wireless device and two of the UWB radios to determine a length and a width of the environment.

4. The system as recited in claim 2, wherein the mapping module is configured to:
determine an initial elevation of the wireless device and a subsequent elevation of the wireless device; and
determine a volume of the environment based on an area of the environment and an elevation delta between the initial elevation and the subsequent elevation of the wireless device.

5. The system as recited in claim 1, further comprising:
a camera device configured to capture an image of the environment;
an object detection module configured to identify the objects in the environment from the captured image; and
wherein the mapping module is configured to determine the location and the relative position of each of the tagged objects and the non-tagged objects in the environment based on the UWB radios and the identified objects in the environment.

6. The system as recited in claim 4, wherein the mapping module is configured to determine the dimensions of an identified object in the environment based on the location and the relative position of the identified object and UWB ranging data received from one or more of the UWB radios in the environment.

7. The system as recited in claim 1, further comprising a wireless device configured to:
implement the mapping module to generate a user interface showing the location of one or more of the objects in the environment; and
initiate to display the user interface on a display screen of the wireless device.

8. The system as recited in claim 6, wherein the mapping module is configured to generate the user interface showing the dimensions of the environment based on measurements determined from the location and relative position of one or more of the UWB radios in the environment.

9. The system as recited in claim 6, wherein the mapping module is configured to:
determine the location of a misplaced object in the environment based on UWB ranging data received from the UWB radio associated with the misplaced object; and
generate the user interface showing the location of the misplaced object in the environment.

10. The system as recited in claim 1, further comprising:
a wireless device configured to implement the mapping module in the environment;
a camera device configured to capture an image of the environment;
an object detection module configured to identify the objects in the environment from the captured image; and
wherein the mapping module is configured to:
generate a depth map showing the relative location of one or more of the objects in the environment, the depth map generated by comparing spatial distances between the identified objects appearing in the captured image and UWB ranging data received from one or more of the UWB radios in the environment; and
generate a user interface to display the depth map on a display screen of the wireless device.

11. A method, comprising:
communicating between a wireless device and ultra-wideband (UWB) radios located in an environment that has objects, including tagged objects and non-tagged objects;
determining a location of each of the tagged objects in the environment based on a position of a UWB radio that is associated with a tagged object;
determining a location of each of the non-tagged objects in the environment based on the positions of the UWB radios;
determining dimensions of the environment and the objects based on the location and a relative position of each tagged object and non-tagged object in the environment.

12. The method as recited in claim 10, wherein the dimensions of the environment are determined by triangulating the wireless device and two of the UWB radios to determine a length and a width of the environment.

13. The method as recited in claim 11, wherein the dimensions of the environment are determined by:
determining an initial elevation of the wireless device and a subsequent elevation of the wireless device; and
determining a volume of the environment based on an area of the environment and an elevation delta between the initial elevation and the subsequent elevation of the wireless device.

14. The method as recited in claim 10, further comprising:
capturing an image of the environment;
identifying the objects in the environment from the captured image; and
wherein the location and the relative position of each of the tagged objects and the non-tagged objects in the environment are determined based on the UWB radios and the identified objects in the environment.

15. The method as recited in claim 13, further comprising:
determining the dimensions of an identified object in the environment based on the location and the relative position of the identified object and UWB ranging data received from one or more of the UWB radios in the environment.

16. The method as recited in claim 10, further comprising:
generating a user interface showing the location of one or more of the objects in the environment; and
displaying the user interface on a display screen of the wireless device.

17. The method as recited in claim 15, wherein the user interface is generated to show the dimensions of the environment based on measurements determined from the location and relative position of one or more of the UWB radios in the environment.

18. The method as recited in claim 15, further comprising:
capturing an image of the environment;
identifying the objects in the environment from the captured image utilizing object detection;
generating a depth map showing the relative location of one or more of the objects in the environment, the depth map generated by comparing spatial distances between the identified objects appearing in the captured image and UWB ranging data received from one or more of the UWB radios in the environment; and
wherein the user interface is generated to display the depth map on a display screen of the wireless device.

19. A system, comprising:
one or more ultra-wideband (UWB) tags located for association with respective devices in an environment, the one or more UWB tags each configured to:
scan for device identifying information broadcast from the devices;
determine a nearest device to a UWB tag for association of the UWB tag with the nearest device; and
communicate location identifying information and an association indication of the UWB tag association with the nearest device to a computing device that implements a mapping module configured to determine dimensions of the environment based on a location and a relative position of each UWB radio in the environment.

20. The system as recited in claim 19, wherein the mapping module is configured to determine the dimensions of each of the devices based on the location and the relative position of each UWB radios in the environment.
